(19) United States
(12) Patent Application Publication
(10) Pub. No.: US 2014/0370345 A1
(43) Pub. Date: Dec. 18, 2014

(54) SEGMENTED ENERGY STORAGE ASSEMBLY

(71) Applicant: MOTOROLA MOBILITY LLC, Libertyville, IL (US)

(72) Inventors: Hossein Maleki, Duluth, GA (US); Steven R. Fischl, Lawrenceville, GA (US); Russell E. Gyenes, Lawrenceville, GA (US); Jerald A. Hallmark, Sugar Hill, GA (US); Jason N. Howard, Alpharetta, GA (US)

(21) Appl. No.: 13/915,771

(22) Filed: Jun. 12, 2013

(51) Int. Cl. H01M 2/10

(52) U.S. Cl. CPC H01M 2/1033
USPC 429/94; 429/99

(57) ABSTRACT

An assembly includes a receiver housing (401) defining a plurality of bays (403,404,405,406,407). Each bay can be separated by a flexible connector section (411,412,413,414). A plurality of electrochemical cells can be disposed in the plurality of bays. A first common conductor (301) can be coupled to each anode of each electrochemical cell, and a second common conductor (302) can be coupled to each cathode of the each electrochemical cell. A cover housing (402) can be coupled to the receiver housing to enclose the plurality of electrochemical cells in the plurality of bays. An exterior housing can be applied to form a wearable strap for, and to power, an electronic device (800).

### BACKGROUND

1. Technical Field

This disclosure relates generally to electronic devices, and more particularly to energy storage devices.

2. Background Art

The world is rapidly becoming portable. As mobile telephones, personal digital assistants, portable computers, tablet computers, and the like become more popular, consumers are continually turning to portable and wireless devices for communication, entertainment, business, and information. Each of these devices owes its portability to a battery. The electrochemical cells operating within a battery provide the user with freedom and mobility.

Prior art batteries are typically formed by placing a wound electrode assembly into a metal can. The resulting pack is rigid and has a fixed physical form factor. Even with newer technologies, such as those used in the manufacture of polymer batteries where an electrode stack is placed into a foil pouch, the resulting battery pack is rigid and has a fixed form factor.

The fixed and rigid nature of prior art battery packs limit the freedom of design in modern electronic devices. It would be advantageous to have an improved energy storage device that allows more design options for electronic devices.

### BRIEF DESCRIPTION OF THE DRAWINGS

FIG. 1 illustrates an explanatory electrode assembly in accordance with one or more embodiments of the disclosure.

FIG. 2 illustrates an explanatory stacked electrode assembly in accordance with one or more embodiments of the disclosure.

FIG. 3 illustrates an explanatory segmented electrode assembly in accordance with one or more embodiments of the disclosure.

FIG. 4 illustrates an explanatory segmented cell housing in accordance with one or more embodiments of the disclosure.

FIG. 5 illustrates an exploded view of an explanatory segmented energy storage device in accordance with one or more embodiment of the disclosure.

FIG. 6 illustrates an explanatory segmented energy storage device in accordance with one or more embodiments of the disclosure.

FIG. 7 illustrates an explanatory energy storage assembly in accordance with one or more embodiments of the disclosure.

FIG. 8 illustrates an explanatory electronic device employing one energy storage assembly configured in accordance with one or more embodiments.

FIG. 9 illustrates another explanatory electrode assembly in accordance with one or more embodiments of the disclosure.

FIG. 10 illustrates an exploded view of another explanatory segmented energy storage device in accordance with one or more embodiment of the disclosure.

FIG. 11 illustrates another explanatory electrode assembly in accordance with one or more embodiments of the disclosure.

FIG. 12 illustrates an exploded view of another explanatory segmented energy storage device in accordance with one or more embodiment of the disclosure.

FIG. 13 illustrates another explanatory electrode assembly in accordance with one or more embodiments of the disclosure.

FIG. 14 illustrates an exploded view of another explanatory segmented energy storage device in accordance with one or more embodiment of the disclosure.

FIG. 15 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Market demands for small portable electronics devices are growing dramatically. Among these are new wearable devices configured to resemble watches. Examples include the devices disclosed in commonly assigned, copending U.S. application Ser. No. 13/297662, entitled “Display Device, Corresponding Systems, and Methods Therefor, Attorney Docket No. CS38607, and U.S. application Ser. No. 13/297965, entitled “Display Device, Corresponding Systems, and Methods for Orienting Output on a Display,” Attorney Docket No. CS38820, each of which is incorporated herein by reference for all purposes. Such devices operate as stand alone devices or, alternatively, can communicate and synchronize with other devices such as smartphones, tablets, or computers. They can provide communication functions, health monitoring functions, and information delivery functions, just to name a few. To facilitate such devices being worn on the wrist, prior art wearable devices required the battery to be quite small so as to fit into the “case” portion of the “watch.” These small batteries limited the time at which the devices could be used between recharging cycles.

Embodiments of the present disclosure provide an alternative energy storage assembly that offers significantly increased “run time” between recharging cycles for wearable devices and other devices having non-traditional physical housings. In one embodiment, an energy storage assembly includes a receiver housing defining a plurality of bays. Each bay can be separated by a flexible connector section of the receiver housing. The flexible connector section allows the receiver housing to bend or flex in areas defined between each bay.

A plurality of electrochemical cells is then disposed in the plurality of bays. Each of the electrochemical cells is coupled in series or parallel, depending upon application, by common conductors. For example, in a parallel configuration, a first common conductor can be coupled to each anode of each electrochemical cell in the plurality of electrochemical cells. Similarly, a second common conductor can be coupled to each cathode of each electrochemical cell in the plurality of electrochemical cells.

A cover housing can then be coupled to the receiver housing to enclose the plurality of electrochemical cells in the plurality of bays. The resulting structure can bend and flex. In one embodiment, the structure can be used in the strap of a wearable device to provide power to electronic circuits. Since multiple cells are used as opposed to the single cell structure found in prior art designs, runtime is significantly increased. At the same time, the flexible nature of the assembly allows the overall electronic device to remain in essentially the same form factor as with prior art designs. Accordingly, despite offering significantly increased run times, by placing cells in the strap of a wearable device, virtually no increase in physical form factor is required.

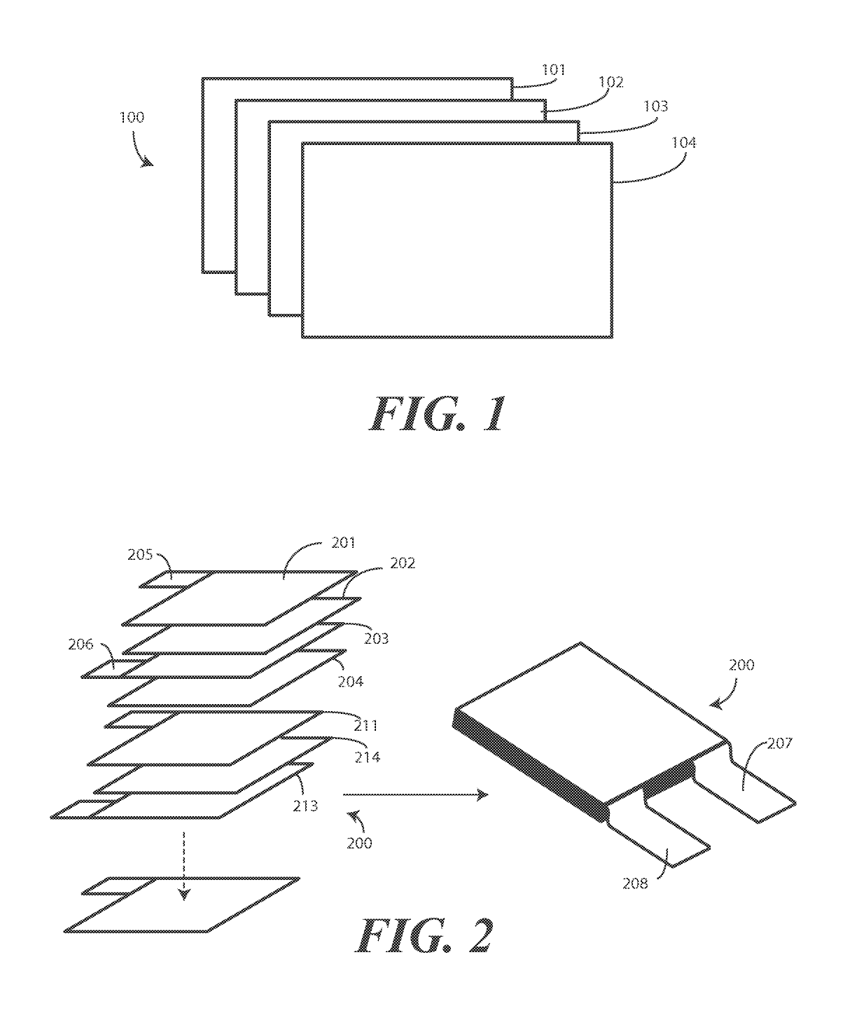

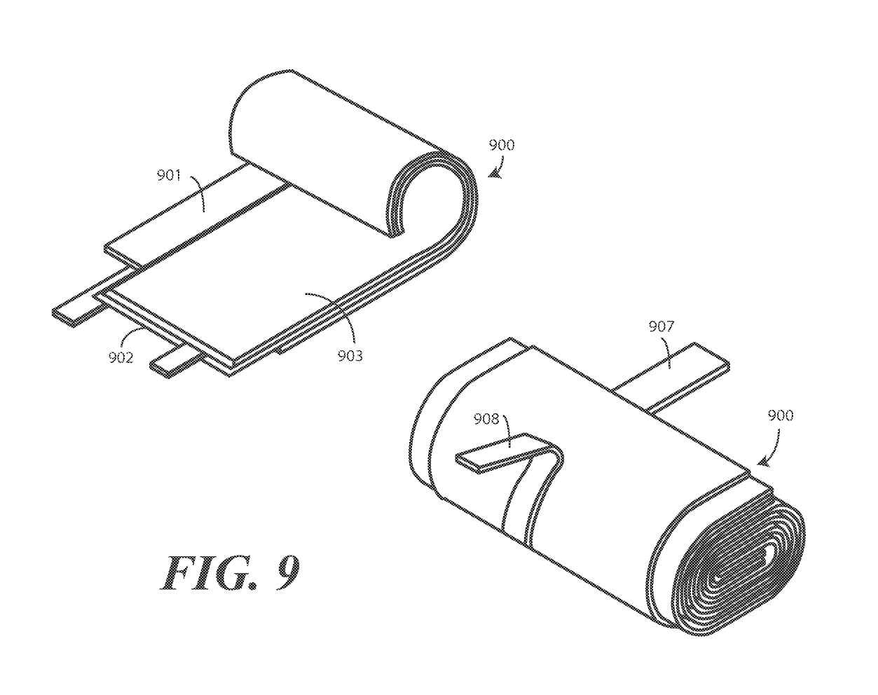

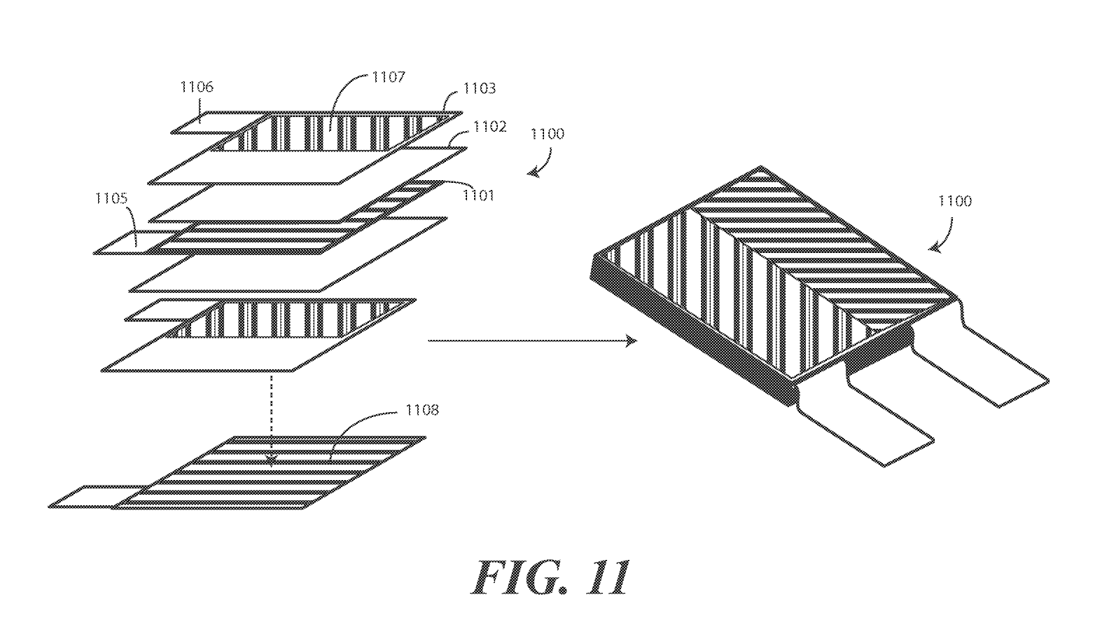

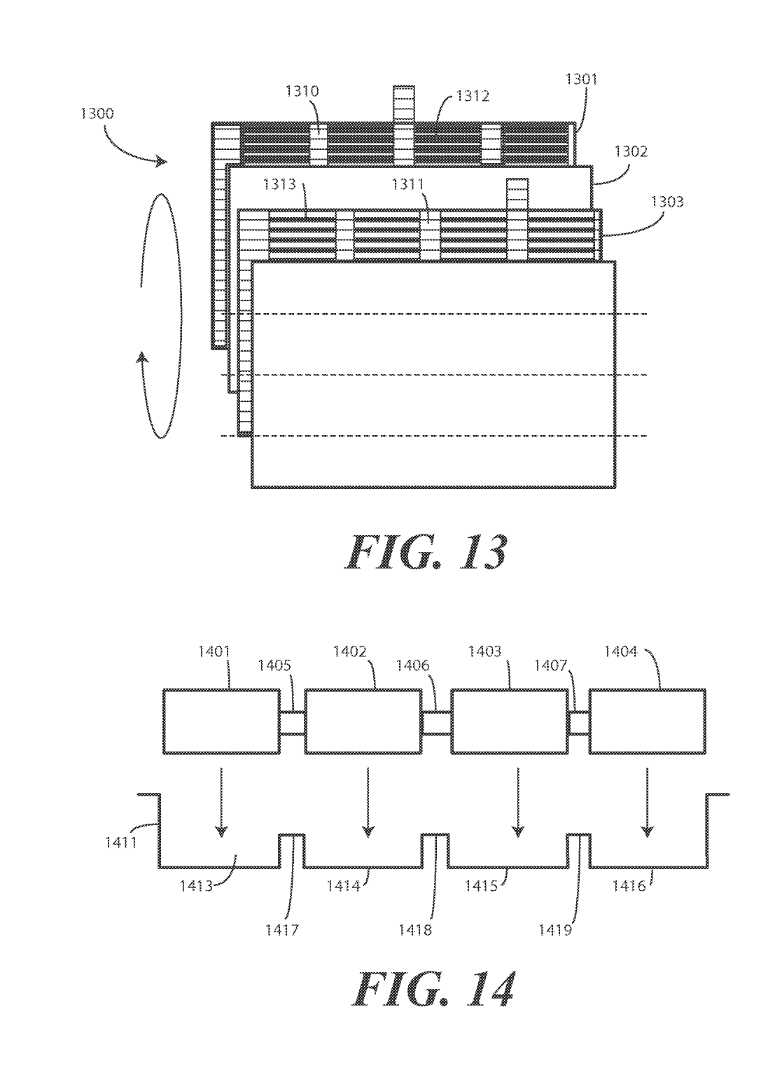

Turning now to FIG. 1, illustrated therein is a general electrode assembly 100 suitable for use in one or more embodiments of the disclosure. As will be shown in further detail below with reference to FIGS. 2 and 9, the electrode assembly 100 can be mechanically configured either in a stacked or wound configuration known as a “jellyroll.” Additionally, as will be shown in further detail below with reference to FIGS. 11 and 13, active portions of the electrode assembly 100, i.e., the anode 101 and cathode 103, can be selectively coated to offer additional design options for one or more energy storage assemblies configured in accordance with embodiments of the disclosure.

For illustration purposes, the electrode assembly 100 described is a lithium-ion electrode assembly. Lithium-ion cells are popular choices for many portable electronic devices. However, it will be clear to those of ordinary skill in the art having the benefit of this disclosure that other electrode assembly structures could also be used in energy storage assemblies described below. For example, rather than using a lithium-ion electrode assembly, a lithium-polymer cell could be used.

The electrode assembly 100 of FIG. 1 comprises an anode 101, a cathode 103, and one or more separator layers 102,104. The anode 101 serves as the negative electrode, while the cathode 103 serves as the positive electrode. The separator layers 102,104 prevent these two electrodes from physically contacting each other. While the separator layers 102,104 physically separate the cathode 103 from the anode 101, the separator layers 102,104 permit ions to pass from the cathode 103 to the anode 101 and vice versa.

In one embodiment, the anode 101 and cathode 103 each comprise a foil layer coated with an electrochemically active material. For example, the anode 101 can include a copper foil layer that is coated with graphite in one embodiment. The cathode 103 can include an aluminum foil layer that is coated with Lithium Cobalt Dioxide (LiCoO.sup.2). The separator layers 102,104 electrically isolate the anode 101 from the cathode 103, and comprise a polymer membrane in one or more embodiments.

The electrode assembly 100 can be placed in an electrolyte. In one embodiment, the electrolyte is an organic electrolyte and provides an ionic conducting medium for lithium ions to move between the anode 101 and cathode 103 during charge and discharge of the electrode assembly 100. As noted above, the anode 101, cathode 103, and separator layers 102,104 can be either wound in a jellyroll configuration or cut and stacked.

While prior art electrode assemblies also use anodes, cathodes, and separators, they are traditionally not well suited for wearable and other “bendable” electronic devices. Jellyroll structures are generally placed into a metal can that is bulky and unwieldy. While cut and stacked structures can be placed in soft packaging, such as aluminum-laminate pouches, they do not lend themselves to repeated bending. This is true because the effectiveness of a lithium-ion electrode assembly is dependent upon the attachment and/or adhesion strength between the anode, cathode, and separator layers. The repetitive bending of the electrode assembly required by wearable or bendable electronics can lead to performance problems including short cycle-life, energy delivery malfunction, or other compromises in operation.

Embodiments of the present disclosure work to allow bending in an energy storage assembly without having to bend the electrode assembly 100. In one embodiment, this is accomplished by placing individual electrode assemblies in bays of a receiver housing. Where the bays are separated by a flexible connector section of the receiver housing, the flexible connector section can bend, thereby allowing the overall structure to “flex” without bending any of the individual electrode assemblies. Said differently, embodiments of the disclosure provide segmented energy storage assemblies that are capable of bending without degrading either the performance or the reliability of the individual electrode assemblies. Accordingly, energy storage assemblies configured in accordance with embodiments of the disclosure are well suited for use in wearable electronics such as smart watches and health monitoring devices that are designed to be worn or strapped around curvilinear limbs or structures.

Turning now to FIG. 2, illustrated therein is an explanatory stacked electrode assembly 200 configured in accordance with one or more embodiments of the disclosure. The stacked electrode assembly 200 includes a plurality of cathodes 203,213 and a plurality of anodes 201,211. While two cathodes 203,213 and two anodes 201,211 are shown for illustrative purposes, in many embodiments the stacked electrode assembly 200 will include a greater number of each.

As shown in FIG. 2, the plurality of cathodes 203,213 and the plurality of anodes 201,211 are cut to a desired shape and then stacked together with a plurality of separators 202,204,214 disposed therebetween. Each cathode of the plurality of cathodes 203,213 and each anode of plurality of anodes 201,211 can include a tab 205,206 electrically coupled to its metal foil layer, which serves as a current collector.

When all layers are placed together, the stacked electrode assembly 200 results. The stacked electrode assembly 200 includes a positive tab 207 coupled to each cathode of the plurality of cathodes 203,213 and a negative tab 208 coupled to each anode of plurality of anodes 201,211 in this embodiment.

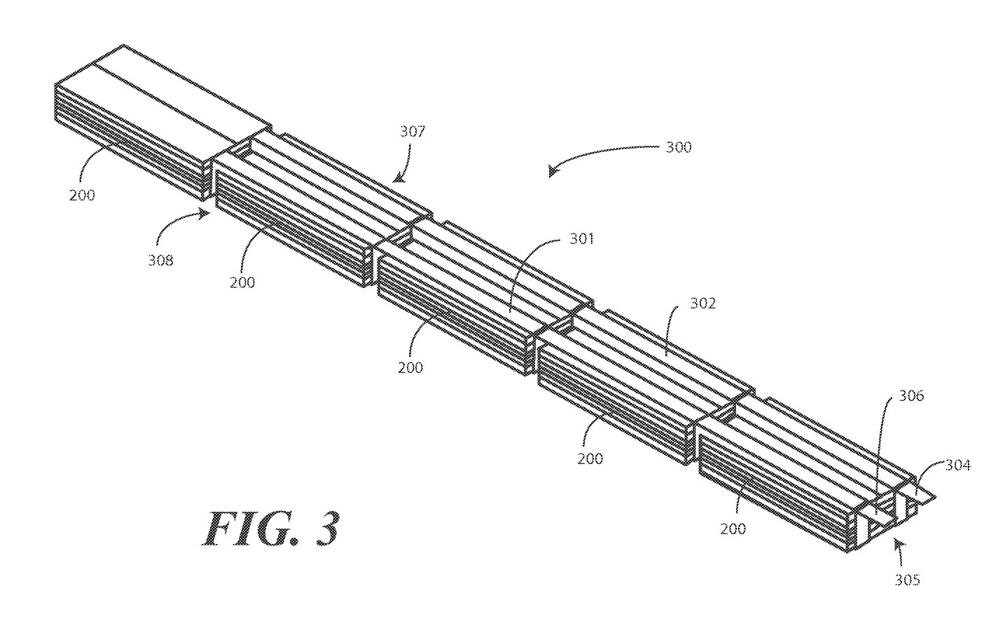

Turning now to FIG. 3, illustrated therein is one explanatory segmented electrode assembly 300 configured in accordance with one or more embodiments. As shown in FIG. 3, a plurality of stacked electrode assemblies 200 are disposed in series. The stacked electrode assemblies 200 of this embodiment are coupled in parallel by a first common conductor 301 and a second common conductor 302. The first common conductor 301 and the second common conductor 303 can be manufactured, in one embodiment, from an electrically conductive, bendable metal such as aluminum or copper. In one embodiment, the first common conductor 301 and the second common conductor 302 are manufactured from the same material. For example, both common conductors can be manufactured from nickel. In another embodiment, the first common conductor 301 and the second common conductor 302 are manufactured from different materials. The first common conductor 301 can be copper while the second common conductor 302 is nickel for example.

In one embodiment, one or both of the first common conductor 301 and the second common conductor 302 are unitary elements. As used herein, “unitary” means a single or uniform entity comprising a single piece of material in accordance with common English parlance. By contrast, a “segmented” element would be a single element that is made from several distinct portions being joined together. Thus, in one embodiment one or both of the first common conductor 301 and the second common conductor 302 comprise a unitary conductor. In other embodiments, one or both of the first common conductor 301 and the second common conductor 302 comprise segmented conductors where multiple conductive elements are soldered, welded, or otherwise electrically coupled together to form a single element.

In one embodiment, the first common conductor 301 is coupled to each anode (201,211) of each stacked electrode assembly 200. For example, the first common conductor 301 can be coupled to each negative tab (208) of each stacked electrode assembly 200. Similarly, in one embodiment, the second common conductor 302 is coupled to each cathode (203,213) of each stacked electrode assembly 200. The second common conductor 302 can be coupled to each positive tab (207) of each stacked electrode assembly 200 in one embodiment.

In one embodiment, one or more of the first common conductor 301 or the second common conductor 302 can include a distally extending portion 304,306 that extends distally beyond an end 305 of the segmented electrode assembly 300. The “end” 305 is used to refer to a minor side when the segmented electrode assembly 300 is viewed in plan view.

In one embodiment, one or more of the first common conductor 301 or the second common conductor 302 is disposed interior to a side 306 of the segmented electrode assembly 300. As used herein, the “side” 306 refers to a major side when the segmented electrode assembly 300 is viewed in plan view. In the embodiment of FIG. 3, both the first common conductor 301 and the second common conductor 302 are disposed interior to the sides 307,308.

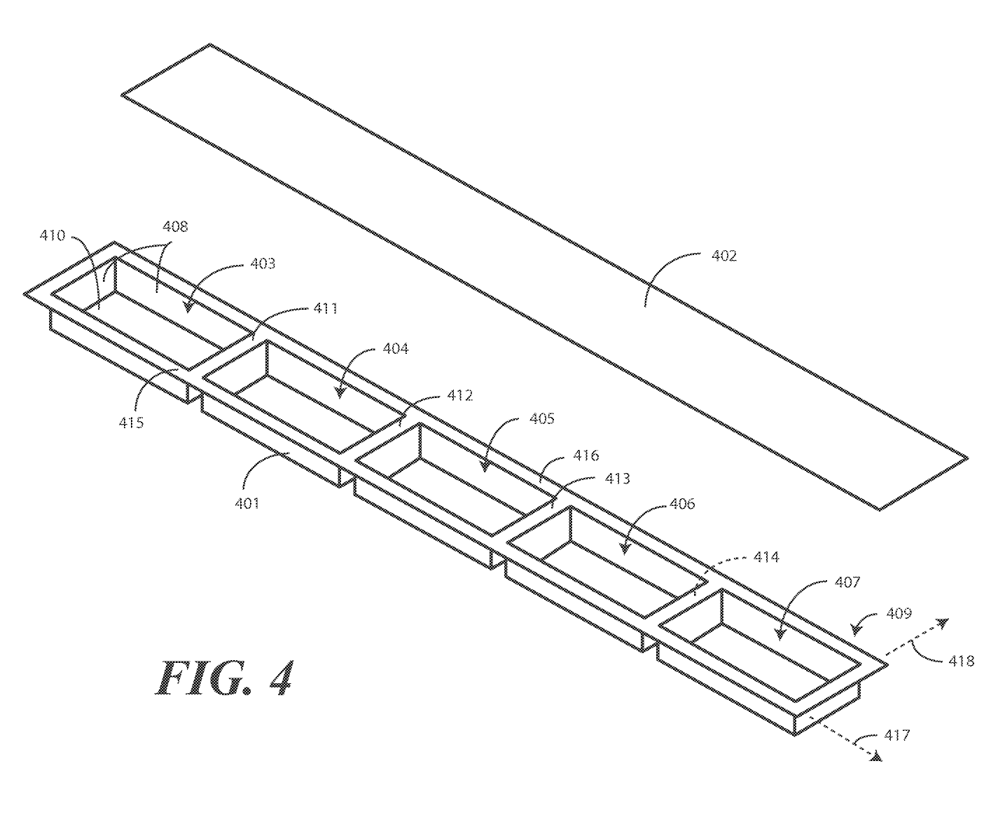

Turning to FIG. 4, illustrated therein is a receiver housing 401 and a cover housing 402 configured in accordance with one or more embodiments of the disclosure. The receiver housing 401 defines a plurality of bays 403,404,405,406,407 in one or more embodiments. Each bay 403,404,405,406,407 can comprise a recess or enclosed area within the receiver housing 401 in one or more embodiments. Using bay 403 as an example, in one embodiment each bay 403 includes one or more sidewalls 408 that extend from an open side 409 of the receiver housing 401 and terminate at a floor 410.

In one embodiment, the receiver housing 401 comprises a unitary housing. For example, in one embodiment the receiver housing 401 and its bays 403,404,405,406,407 can be manufactured from a single piece of molded thermoplastic. In one embodiment, the thermoplastic comprises a flexible plastic or plastic material to allow for its easy bending and twisting. In other embodiments, the housing 401 can be manufactured from laminated foil. Illustrating by example, a foil core layer can be coated in another material, such as plastic, to form the laminate foil.

In one embodiment, each bay 403,404,405,406,407 is separated by a flexible connector section 411,412,413,414 defined in the receiver housing 401. Where the material from which the receiver housing 401 is manufactured is flexible, each flexible connector section 411,412,413,414 can be configured to bend and flex between each bay 403,404,405,406,407. In one embodiment, the receiver housing 401 can optionally include one or more exterior ledges 415 having a major axis 417 substantially orthogonal with and axis 418 of the flexible connector sections 411,412,413,414.

In one embodiment, various portions of the receiver housing 401 can be configured to have different flex or bend coefficients. For example, in one embodiment each bay 403,404,405,406,407 can be configured to be stiffer than each flexible connector section 411,412,413,414 to allow the latter to bend of flex more readily than the former. In one embodiment, the different bend coefficients can be created by varying the thickness of portions of the receiver housing 401. Portions that are to bend less can be thicker while portions that are to bend more can be made thinner and so forth.

The cover housing 402 can be configured to couple to the receiver housing 401 to enclose and seal each bay 403,404,405,406,407. For example, the cover housing 402 can be manufactured from a flexible thermoplastic as is the receiver housing 401. In other embodiments, the cover housing 402 can be manufactured from laminated foil. The cover housing 402 can be thermally bonded to the receiver housing 401, adhesively bonded to the receiver housing 401, sonically welded to the receiver housing 401, or otherwise coupled to the receiver housing 401. When so coupled, the cover housing 402 and the receiver housing 401 form a sealed housing assembly.

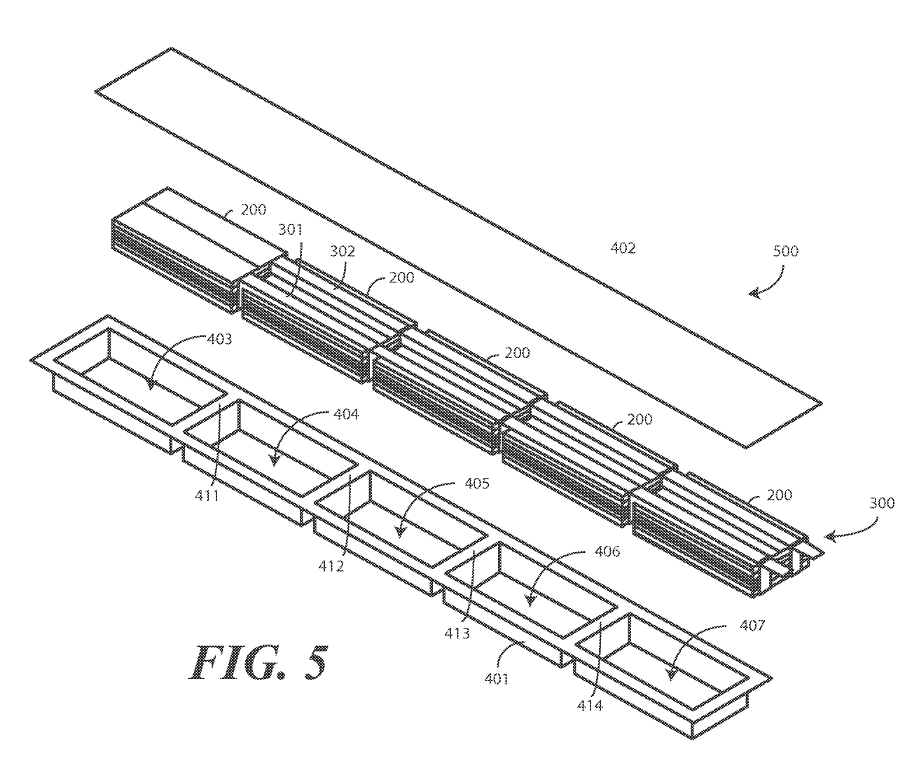

Turning now to FIG. 5, illustrated therein is an exploded view of one explanatory segmented energy storage assembly 500 configured in accordance with one or more embodiments of the disclosure. As shown in FIG. 5, the segmented electrode assembly 300 of FIG. 3 is placed into the receiver housing 401 such that each stacked electrode assembly 200 is disposed in the plurality of bays 403,404,405,406,407. In this embodiment, the stacked electrode assemblies 200 seat within bays 403,404,405,406,407 on a one to one basis. Each bay 403,404,405,406,407 can then be filled with electrolyte to transform the stacked electrode assemblies 200 into electrochemical cells.

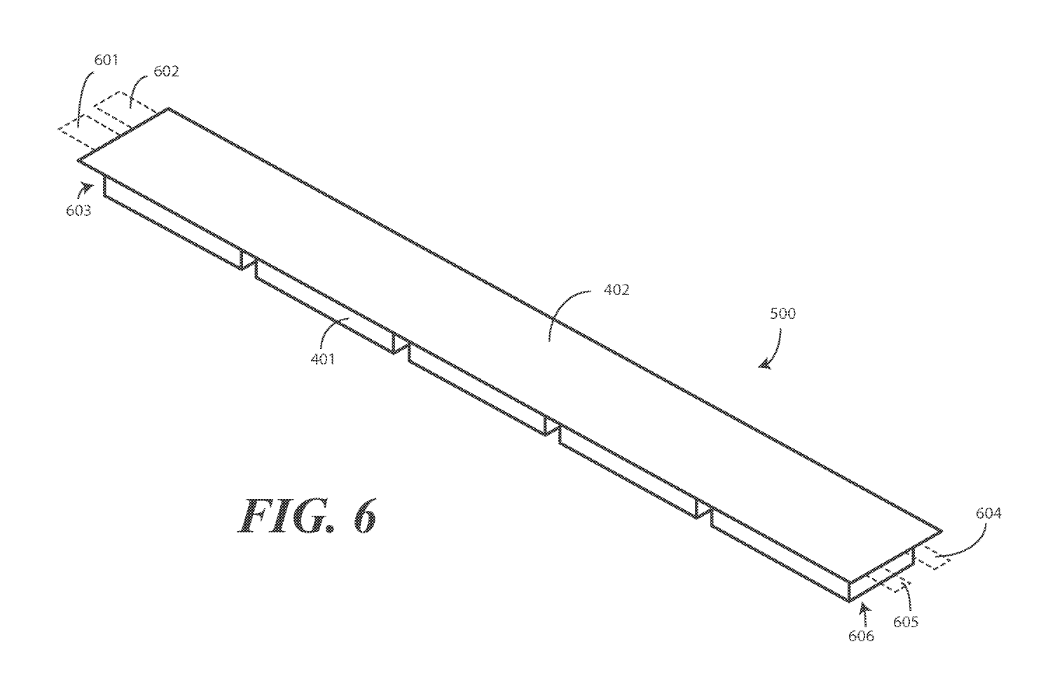

When the stacked electrode assemblies 200 are disposed within the bays 403,404,405,406,407, the first common conductor 301 and the second common conductor 302 traverse from bay to bay across the flexible connector sections 411,412,413,414. Said differently, when each electrode assembly is seated within its corresponding bay, the first common conductor 301 and the second common conductor 302 pass from one electrochemical cell in one bay to another electrochemical cell in another bay by passing over a flexible connection section. Illustrating by example, when connecting the stacked electrode assembly 200 in bay 403 to an stacked electrode assembly 200 in bay 404, both the first common conductor 301 and the second common conductor 302 will pass over flexible connector section 411. The cover housing 402 is then coupled to the receiver housing 401 such that the first common conductor 301 and/or the second common conductor 302 traverses bays 403,404,405,406,407 between the flexible connector sections 411,412,413,414 and the cover housing 402. The resulting complete segmented energy storage assembly 500 is shown in FIG. 6.

Turning now to FIG. 6, in one or more embodiments one or more of the first common conductor (301) and the second common conductor (302) have a portion thereof external to the assembly forming the segmented energy storage assembly 500. For illustrative purposes, in the embodiment shown in FIG. 6, portions 601,602 extend from a first end 603 of the assembly and portions 604,605 extend from a second end 606 of the assembly to demonstrate that the portions could extend from the first end 603, the second end 606, or combinations thereof. In many embodiments, the portions will only extend from a single end, as a mechanical clasp or latch may be disposed at the distal end relative to the portions.

In one embodiment, the portions extending from the assembly can be extensions of the common conductors themselves. For example, portions 604,605 can comprise portions of the second common conductor (302) and first common conductor (301), respectively, that are external to the assembly.

In another embodiment, the portions can be conductors coupled to the common conductors. For example, portions 601 can comprise a first exterior conductor electrically coupled with the first common conductor (301) and portion 602 can comprise a second exterior conductor electrically coupled with the second common conductor (302). As shown in FIG. 6, in one embodiment at least a portion 601,602 of the first exterior conductor and the second exterior conductor can be disposed external to the assembly formed by the receiver housing 401 and the cover housing 402.

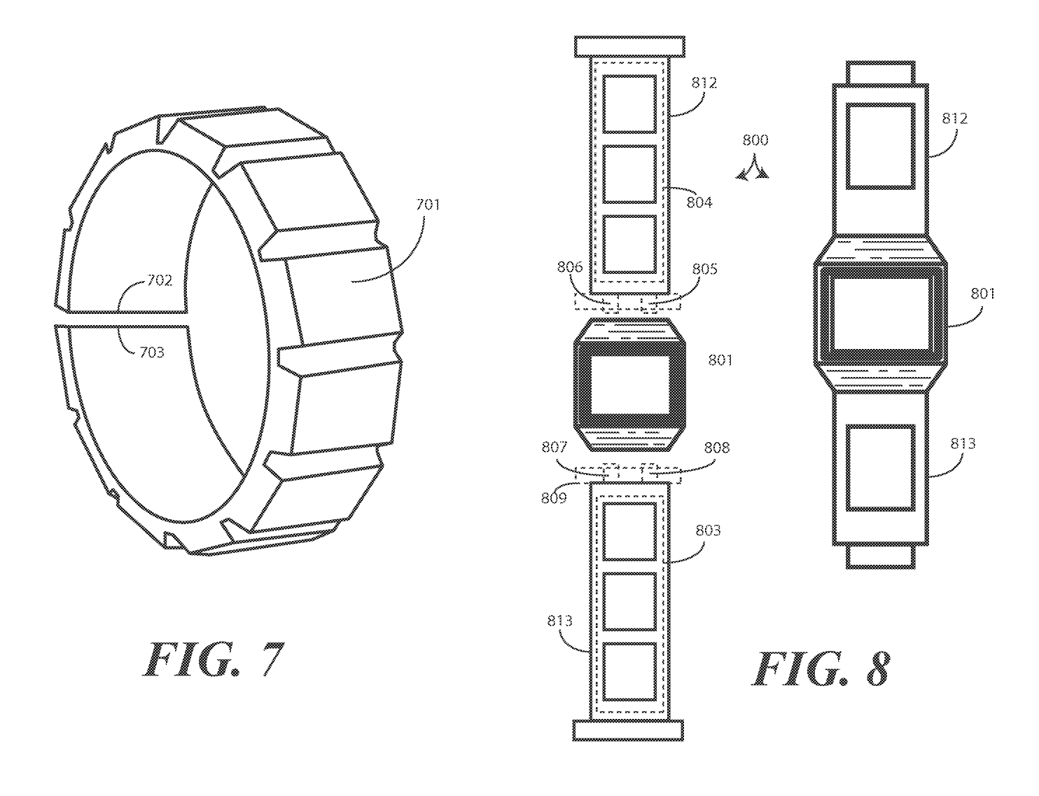

The assembly can, in one or more embodiments, be used as a strap for an electronic device. Turning now to FIG. 7, the segmented energy storage assembly (500) of FIG. 6 has been inserted into a mechanical housing 701. The mechanical housing 701 provides mechanical structure, and optionally an aesthetically pleasing appearance, for the segmented energy storage assembly (500). When the flexible connector sections (411,412,413,414) of the segmented energy storage assembly (500) flex, the mechanical housing 701 appears to be a segmented or linked bracelet on a watch or other wrist-worn device. Mechanical couplers can be coupled to the ends 702,703 of the mechanical housing 701 to serve as a clasp for the segmented or linked bracelet.

To illustrate this in more detail, turning now to FIG. 8, illustrated therein is one embodiment of an electronic device 800 configured in accordance with one or more embodiments of the disclosure. The explanatory electronic device 800 of FIG. 8 is configured as a wearable device.

The electronic device 800 includes a component portion 801 and a strap 802. In one embodiment, the strap 802 comprises two mechanical housings 812,813, similar to that shown in FIG. 7, enclosing two segmented energy storage devices 803,804, similar to that shown in FIG. 6, which are coupled together to form a wrist wearable device. As the segmented energy storage devices 803,804 include flexible connector sections between bays, the strap 802 is pliant without deforming each electrochemical cell disposed in each bay. The term “pliant” is used to refer to a strap 802 that is one or more of pliant, compressible, yielding, bending, or otherwise deformable, in response to forces applied thereto.

In this illustrative embodiment, the component portion 801 serves as the nerve center of the device as it houses the electronic components of the device, including the processing circuitry, memory circuitry, and display circuitry. The electrochemical cells disposed in the bays of the segmented energy storage devices 803,804 provide power to the electronic components through external portions 805,806,807,808 that are electrically coupled to components in the component portion 801. In one embodiment, external portions 805,806,807,808 are disposed in a hinge 809 that mechanically couples to the component portion 801. The resulting structure looks and feels like a wrist watch.

Turning now to FIG. 9, illustrated therein is another explanatory electrode assembly 900 configured in accordance with one or more embodiments of the disclosure. The electrode assembly 900 of FIG. 9 is an alternative to the stacked electrode assembly (200) of FIG. 2.

In FIG. 9, the electrode assembly 900 is configured as a jellyroll. One or more anodes 901, one or more separators 902, and one or more cathodes 903 are simultaneously wound to result in a cylindrically shaped coil that resembles a culinary jellyroll. The layers can be wound with or without the use of a core. In one embodiment the cathodes 903 and the anodes 901 have the same length. However, in other embodiments, as shown in the completed electrode assembly 900 of FIG. 9, the cathodes 903 and anodes 901 can have different lengths as well. This results in the cathodes 903 and the anodes 901 having different areas of active electrode material. Further, the actual number of layers or windings applied to the jellyroll may vary to create different electrode assembly configurations in one or more embodiments. The electrode assembly 900 includes a positive tab 907 coupled to the cathodes 903 and a negative tab 908 coupled to the anodes 901 in this embodiment.

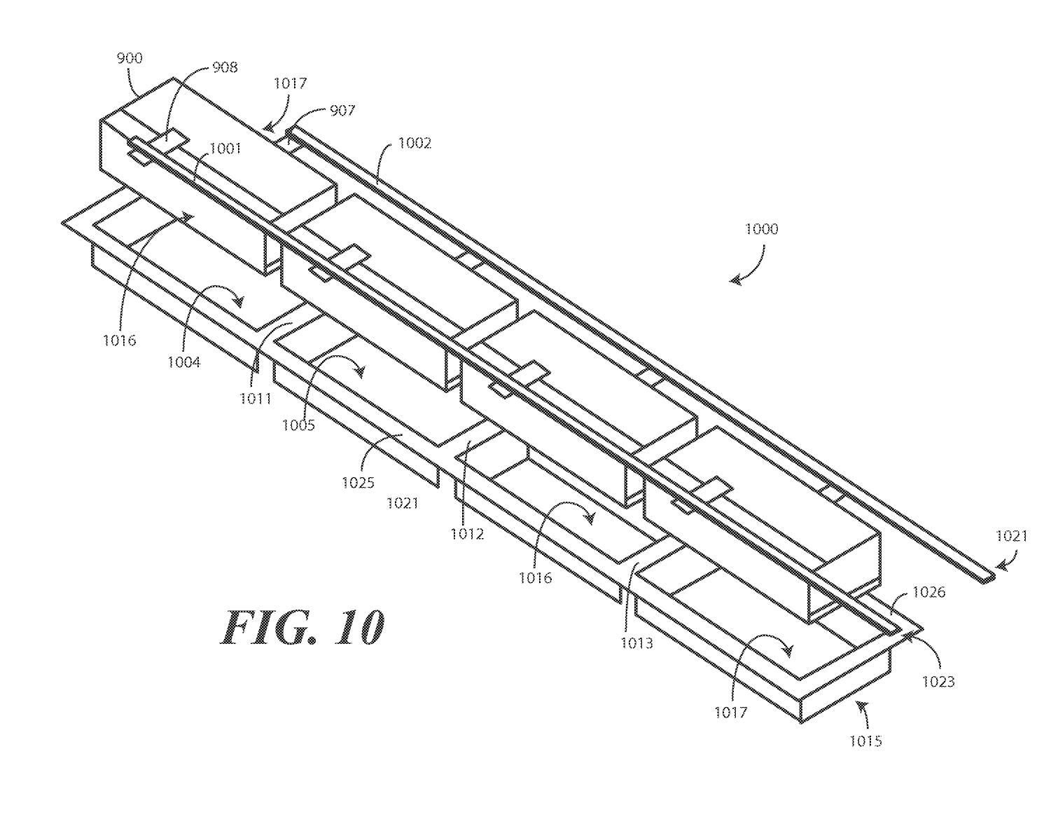

Turning now to FIG. 10, illustrated therein is another explanatory segmented electrode assembly 1000 configured in accordance with one or more embodiments. As shown in FIG. 10, a plurality of electrode assemblies 900 is disposed in series. Each electrode assembly 900 of this embodiment is wound into a jellyroll configuration.

The electrode assemblies 900 of this embodiment are coupled electrically in parallel by a first common conductor 1001 and a second common conductor 1002. The first common conductor 1001 and the second common conductor 1002 can be manufactured, in one embodiment, from an electrically conductive, bendable metal such as aluminum or copper. In one embodiment, the first common conductor 1001 and the second common conductor 1002 are manufactured from the same material. In another embodiment, the first common conductor 1001 and the second common conductor 1002 are manufactured from different materials.

In one embodiment, one or both of the first common conductor 1001 and the second common conductor 1002 are unitary elements. In other embodiments, one or both of the first common conductor 1001 and the second common conductor 1002 comprise segmented conductors coupled together to form a single element.

In one embodiment, the first common conductor 1001 is coupled to each anode (901) of each electrode assembly 900. For example, the first common conductor 1001 can be coupled to each negative tab 908 of each electrode assembly 900. Similarly, in one embodiment, the second common conductor 1002 is coupled to each cathode (903) of each electrode assembly 900. The second common conductor 1002 can be coupled to each positive tab 907 of each electrode assembly 900 in one embodiment.

In one embodiment, one or more of the first common conductor 1001 or the second common conductor 1002 can include a distally extending portion 1023,1024 that extends distally beyond an end 1015 of the segmented electrode assembly 1000.

In one embodiment, one or more of the first common conductor 1001 or the second common conductor 1002 is disposed exterior to a side 1016 of the segmented electrode assembly 1000. In the embodiment of FIG. 10, both the first common conductor 1001 and the second common conductor 1002 are disposed exterior to the sides 1016,1017.

Also shown in FIG. 10 is a receiver housing 1021. The receiver housing 1021 defines a plurality of bays 1003,1004,1005,1006,1007 in one or more embodiments. Each bay 1003,1004,1005,1006,1007 can comprise a recess or enclosed area within the receiver housing 1021 to receive the electrode assemblies 900.

As with the embodiment of FIG. 4, the receiver housing 1021 of FIG. 10 includes a flexible connector section 1011,1012,1013 disposed between each bay 1003,1004,1005,1006,1007. The flexible connector sections 1011,1012,1013 can be configured to bend and flex between each bay 1003,1004,1005,1006,1007.

In this embodiment, the receiver housing 1021 also includes one or more exterior ledges 1025,1026. When the electrode assemblies 900 are disposed within the bays 1003,1004,1005,1006,1007, the first common conductor 1001 and the second common conductor 1002 traverse from bay to bay across the ledges 1025,1026. Electrolyte can be added to each bay 1003,1004,1005,1006,1007 to transform the electrode assemblies 900 into electrochemical cells. A cover housing (402) can then be coupled to the receiver housing 1021 to enclose the electrochemical cells in the bays 1003,1004,1005,1006,1007. When this occurs, one or more of the first common conductor 1001 or the second common conductor 1002 is disposed between the exterior ledges 1025,1026 and the cover housing (402).

Turning now to FIG. 11, illustrated therein is an alternate stacked electrode assembly 1100. In FIG. 11 the stacked electrode assembly 1100 includes a plurality of cathodes 1103 and a plurality of anodes 1101. The plurality of cathodes 1103 and the plurality of anodes 1101 are cut to a desired shape and then stacked together with a plurality of separators 1102 disposed therebetween. Each cathode of the plurality of cathodes 1103 and each anode of plurality of anodes 1101 can include a tab 1105,1106 as previously described.

In the embodiment of FIG. 11, the anodes 1101 and cathodes 1103 are only coated with electrochemically active material 1107,1108 on only one side of the foil layer. Moreover, in this illustrative embodiment, the area of the electrochemically active material 1107 coating the cathodes 1103 has less area than the electrochemically active material 1108 coating the anodes 1101. This is due to selectively coating the cathodes 1103. In this illustrative embodiment, the area of the electrochemically active material 1107 coating the cathodes 1103 is about half the electrochemically active material 1108 coating the anodes 1101. When all layers are placed together, the stacked electrode assembly 1100 results.

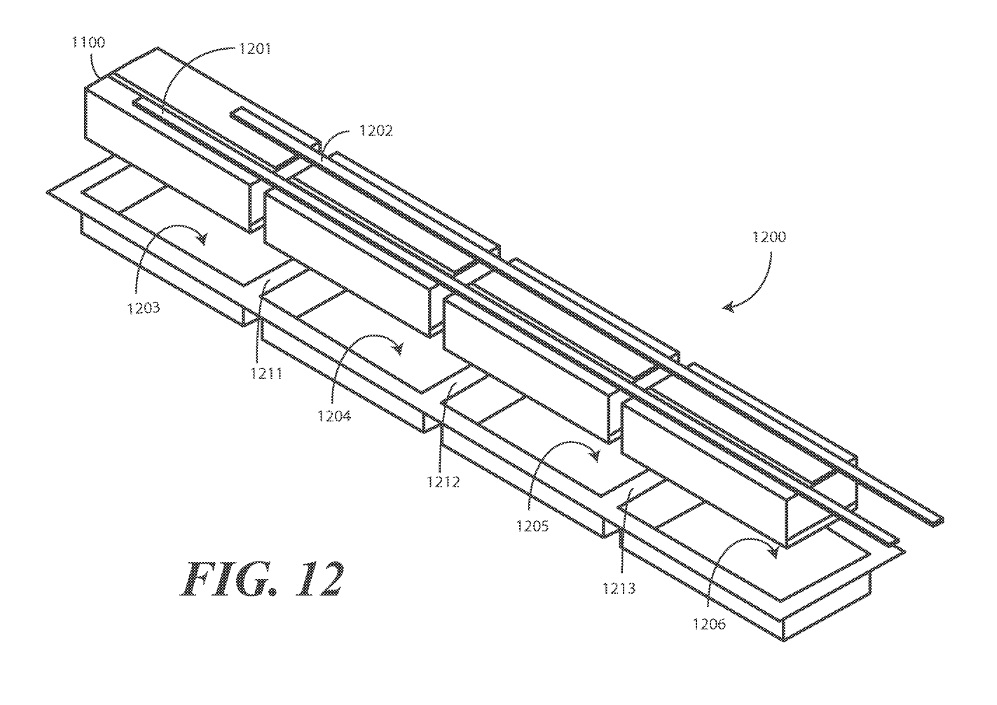

Turning now to FIG. 12, illustrated therein is another explanatory segmented electrode assembly 1200 using the electrode assemblies 1100 of FIG. 11. As shown in FIG. 12, a plurality of electrode assemblies 1100 is disposed in series. Each electrode assembly 1100 of this embodiment has a cathode (1103) having less active area than its anode (1104).

The electrode assemblies 1100 of this embodiment are coupled electrically in parallel by a first common conductor 1201 and a second common conductor 1202. The first common conductor 1201 and the second common conductor 1202 can be manufactured, in one embodiment, from an electrically conductive, bendable metal such as aluminum or copper. Where one or more of the anode (1101) or the cathode (1103) comprising a coated side and an uncoated side as described above with reference to FIG. 11, the first common conductor 1201 or the second common conductor 1202 is electrically coupled to the coated side.

In one embodiment, one or both of the first common conductor 1201 and the second common conductor 1202 are unitary elements. In other embodiments, one or both of the first common conductor 1201 and the second common conductor 1202 comprise segmented conductors coupled together to form a single element.

In one embodiment, the first common conductor 1201 is coupled to each anode (1101) of each electrode assembly 1100. In this embodiment, both the first common conductor 1201 and the second common conductor 1202 are disposed exterior to the sides 1216,1217 of the electrode assembly. When the electrode assemblies 1100 are disposed within the bays 1203,1204,1205,1206, the first common conductor 1201 and the second common conductor 1202 traverse from bay to bay across flexible connector sections 1211,1212,1213 disposed between the bays 1203,1204,1205,1206. Electrolyte can be added to each bay 1203,1204,1205,1206 to transform the electrode assemblies 1100 into electrochemical cells. A cover housing (402) can then be coupled to the receiver housing 1221 to enclose the electrochemical cells in the bays 1203,1204,1205,1206. When this occurs, one or more of the first common conductor 1201 or the second common conductor 1202 is disposed between the flexible connector sections 1211,1212,1213 and the cover housing (402).

Turning now to FIG. 13, illustrated therein is yet another electrode assembly 1300 configured in accordance with embodiments of the disclosure. As with previous embodiments, the electrode assembly can be disposed in a receiver housing defining a plurality of bays, with each bay separated by a flexible connector section of the receiver housing. However, in the embodiment of FIG. 13, the foil layers 1310,1311 of the anode 1301 and cathode 1303, respectively, due to the fact that electrochemically active material 1312,1313 is selectively disposed along the foil layers 1310,1311. In this embodiment, that electrochemically active material 1312,1313 is selectively disposed in overlapping rows along the foil layers 1310,1311. Separator layers 1302 are then placed between the anode 1301 and the cathode 1303.

As shown in FIG. 14, when the layers are wound into a jellyroll, the coated portions 1401,1402,1403,1404 are thicker than are the uncoated portions 1405,1406,1407. Accordingly, when the assembly is placed in a receiver housing 1411 defining a plurality of bays 1413,1414,1415,1416, the coated portions 1401,1402,1403,1404 form the electrochemical cells disposed within the bays 1413,1414,1415,1416 due to the fact that they are thicker. Meanwhile, the uncoated portions 1405,1406,1407 serve as the common conductors and traverse the flexible connector sections 1417,1418,1419, which can be shallower than in previous embodiments. The resulting assembly, as with the assemblies of FIGS. 5, 10, and 12, can then serve as a flexible battery assembly for an electronic device as previously described.

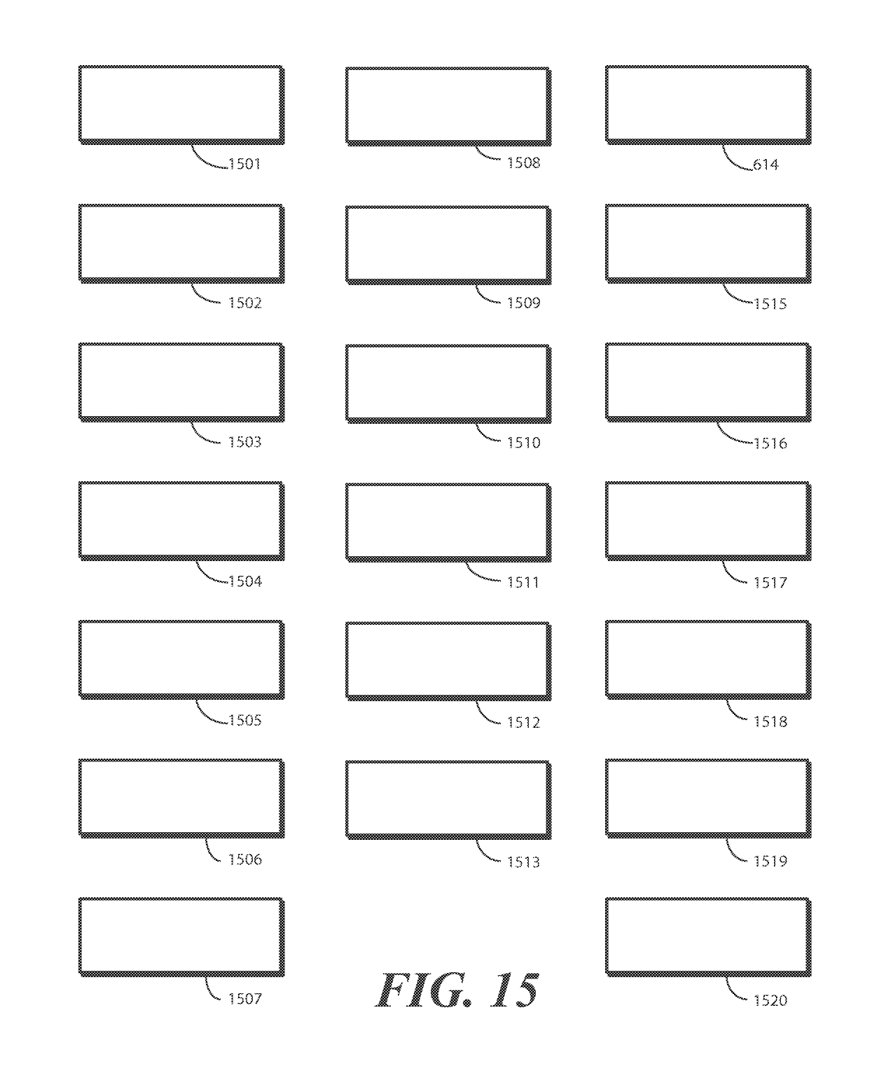

Turning now to FIG. 15, illustrated therein are various embodiments of the disclosure. At 1501, an assembly comprises a receiver housing defining a plurality of bays, each bay separated by a flexible connector section of the receiver housing. At 1501, a plurality of electrochemical cells is disposed in the plurality of bays. At 1501, a first common conductor is coupled to each anode of each electrochemical cell in the plurality of electrochemical cells. At 1501, a second common conductor is coupled to each cathode of the each electrochemical cell in the plurality of electrochemical cell. At 1501, a cover housing coupled to the receiver housing to enclose the plurality of electrochemical cells in the plurality of bays.

At 1502, the receiver housing of 1501 comprises a unitary housing. At 1503, the receiver housing of 1502 is manufactured from a flexible thermoplastic. At 1504, the flexible connector section of 1503 has a different bend coefficient than the plurality of bays. At 1505, the first common conductor of 1501 and the second common conductor of 1501 have a portion thereof external to the assembly.

At 1506, the assembly of 1501 further comprises a first exterior conductor electrically coupled with the first common conductor. At 1506, a second exterior conductor is electrically coupled with the second common conductor. At 1506, at least a portion of the first exterior conductor and the second exterior conductor is disposed external to the receiver housing and the cover housing.

At 1507, one or more electrochemical cells of 1501 comprise a stacked electrode assembly. At 1508, one or more of the first common conductor of 1507 or the second common conductor of 1507 traverse bays between the flexible connector section and the cover housing.

At 1509, each cathode of 1508 has less area than the each anode. At 1510, one or more electrochemical cells of 1501 are wound in a jellyroll. At 1511, the receiver housing of 1510 defines one or more exterior ledges having a major axis substantially orthogonal with flexible connector sections. At 1511, one or more of the first common conductor or the second common conductor of 1510 is disposed between the one or more exterior ledges and the cover housing.

At 1512, one or more of the anode of 1501 or the cathode of 1501 comprises a coated side and an uncoated side. At 1512, the first common conductor or the second common conductor of 1501 is electrically coupled to the coated side.

At 1513, one or more of the anode of 1501 or the cathode of 1501 comprise selectively coated portions and uncoated portions. At 1514, the one or more electrochemical cells of 1513 are wound in a jellyroll, the uncoated portions thinner along the jellyroll than the selectively coated portions. At 1515, the uncoated portions of 1514 traverse the flexible connector section and the selectively coated portions disposed in the plurality of bays.

At 1516, an assembly comprises a flexible energy storage assembly. At 1516, the flexible energy storage assembly comprises a receiver housing defining a plurality of bays, with each bay separated by a flexible connector section of the receiver housing and having an electrochemical cell disposed therein. At 1516, a first common conductor is coupled to each electrochemical cell anode and a second common conductor is coupled to each electrochemical cell cathode. At 1516, the first common conductor and the second common conductor traverse the flexible connector section. At 1516, a cover housing encloses an electrochemical cell in each bay. At 1516, a connector is coupled to the flexible energy storage assembly. At 1516, the connector comprises electrical conductors coupled to the first common conductor and the second common conductor, respectively.

At 1517, the assembly of 1516 also comprises an electronic device coupled to the connector. At 1517, the electronic device of 1516 receives energy from the electrochemical cell.

At 1518, the assembly of 1516 further comprises an exterior mechanical housing enclosing the flexible energy storage assembly. At 1519, the exterior mechanical housing of 1518 defines a wearable strap for the electronic device. At 1520, the electrochemical cell of 1519 comprises an anode, a cathode, and a separator, with at least one of the anode or the cathode comprising selective coating.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. An assembly, comprising:
a receiver housing defining a plurality of bays, each bay separated by a flexible connector section of the receiver housing;
a plurality of electrochemical cells disposed in the plurality of bays;
a first common conductor coupled to each anode of each electrochemical cell in the plurality of electrochemical cells;
a second common conductor coupled to each cathode of the each electrochemical cell in the plurality of electrochemical cells; and
a cover housing coupled to the receiver housing to enclose the plurality of electrochemical cells in the plurality of bays.

2. The assembly of claim 1, the receiver housing comprising a unitary housing.

3. The assembly of claim 2, the receiver housing manufactured from a flexible thermoplastic.

4. The assembly of claim 3, the flexible connector section having a different bend coefficient than the plurality of bays.

5. The assembly of claim 1, the first common conductor and the second common conductor having a portion thereof external to the assembly.

6. The assembly of claim 1, further comprising:
a first exterior conductor electrically coupled with the first common conductor; and
a second exterior conductor electrically coupled with the second common conductor;
at least a portion of the first exterior conductor and the second exterior conductor disposed external to the receiver housing and the cover housing.

7. The assembly of claim 1, one or more electrochemical cells comprising a stacked electrode assembly.

8. The assembly of claim 7, one or more of the first common conductor or the second common conductor traversing bays between the flexible connector section and the cover housing.

9. The assembly of claim 8, the each cathode having less area than the each anode.

10. The assembly of claim 1, one or more electrochemical cells wound in a jellyroll.

11. The assembly of claim 10, the receiver housing defining one or more exterior ledges having a major axis substantially orthogonal with flexible connector sections, one or more of the first common conductor or the second common conductor disposed between the one or more exterior ledges and the cover housing.

12. The assembly of claim 1, one or more of the each anode or the each cathode comprising a coated side and an uncoated side, the first common conductor or the second common conductor electrically coupled to the coated side.

13. The assembly of claim 1, one or more of the each anode or the each cathode comprising selectively coated portions and uncoated portions.

14. The assembly of claim 13, the one or more electrochemical cells wound in a jellyroll, the uncoated portions thinner along the jellyroll than the selectively coated portions.

15. The assembly of claim 14, the uncoated portions traversing the flexible connector section and the selectively coated portions disposed in the plurality of bays.

16. An assembly, comprising:
a flexible energy storage assembly comprising:
a receiver housing defining a plurality of bays, each bay separated by a flexible connector section of the receiver housing and having an electrochemical cell disposed therein;
a first common conductor coupled to each electrochemical cell anode and a second common conductor coupled to each electrochemical cell cathode, the first common conductor and the second common conductor traversing the flexible connector section; and
a cover housing enclosing the electrochemical cell in the each bay; and
a connector coupled to the flexible energy storage assembly, the connector comprising electrical conductors coupled to the first common conductor and the second common conductor, respectively.

17. The assembly of claim 16, further comprising an electronic device coupled to the connector, the electronic device receiving energy from the electrochemical cell.

18. The assembly of claim 17, further comprising an exterior mechanical housing enclosing the flexible energy storage assembly.

19. The assembly of claim 18, the exterior mechanical housing defining a wearable strap for the electronic device.

20. The assembly of claim 16, the electrochemical cell comprising an anode, a cathode, and a separator, at least one of the anode or the cathode comprising selective coating.
